(19) United States
(12) Patent Application Publication
(10) Pub. No.: US 2020/0086789 A1
(43) Pub. Date: Mar. 19, 2020

(54) MIXED REALITY LEFT TURN ASSISTANCE TO PROMOTE TRAFFIC EFFICIENCY AND ENHANCED SAFETY

(71) Applicant: Valeo Comfort and Driving Assistance, Creteil (FR)

(72) Inventors: Christopher Steven NOWAKOWSKI, San Francisco, CA (US); David Saul HERMINA MARTINEZ, San Mateo, CA (US); Delbert Bramlett BOONE, II, Redwood City, CA (US); Eugenia Yi Jen LEU, San Mateo, CA (US); Mohamed Amr Mohamed Nader ABUELFOUTOUH, San Mateo, CA (US); Sonam NEGI, Sunnyvale, CA (US); Tung Ngoc TRUONG, San Jose, CA (US)

(21) Appl. No.: 16/130,750

(22) Filed: Sep. 13, 2018

(51) Int. Cl. B60R 1/00; G06T 19/00

(52) U.S. Cl. CPC B60R 1/00; G06T 19/006; B60R 2300/205; B60R 2300/80; B60R 2300/303

(57) ABSTRACT

Methods, apparatuses, and computer-readable media are disclosed for providing a mixed-reality scene. According to one embodiment, a sequence of mixed-reality images is presented to a driver of a first vehicle, the first vehicle oriented in a substantially opposing direction relative to a second vehicle. At least one image in the sequence of mixed-reality images may result from merging (a) an image captured by a forward-facing camera aboard the first vehicle and (b) an image captured by a rear-facing camera aboard the second vehicle. The merging may comprise de-emphasizing an occluded portion of the image captured by the forward-facing camera aboard the first vehicle, the occluded portion corresponding to occlusion by the second vehicle, and emphasizing an unoccluded portion of the image captured by the rear-facing camera aboard the second vehicle.

### BACKGROUND

Aspects of the disclosure relate to promoting traffic efficiency and enhancing safety for vehicular maneuvers performed under limited visibility of on-coming traffic. An example of such a vehicular maneuver is an unprotected left turn, in which a vehicle performs a left turn across on-coming traffic without a protected left-turn signal. Oftentimes, the view of the driver of the vehicle making such an unprotected left turn can be blocked by another vehicle positioned in the opposite direction, also attempting to make an unprotected left turn. Each vehicle blocks the view of the driver of the other vehicle, such that on-coming traffic is less visible. A driver making an unprotected left turn under such conditions is at a heightened risk of becoming involved in a collision with on-coming traffic. Existing techniques for improving left-turn traffic efficiency and safety have significant deficiencies, including the need to install costly equipment such as traffic signals, infrastructure sensors, etc., as well as a lack of effectively perceivable visual cues for facilitating driver awareness of on-coming traffic. Thus, improvements are urgently needed to promote traffic efficiency and enhance safety associated with unprotected left turns.

### BRIEF SUMMARY

Methods, apparatuses, and computer-readable media are disclosed for providing a mixed-reality scene. According to one embodiment, a sequence of mixed-reality images is presented to a driver of a first vehicle, the first vehicle oriented in a substantially opposing direction relative to a second vehicle. At least one image in the sequence of mixed-reality images may result from merging (a) an image captured by a forward-facing camera aboard the first vehicle and (b) an image captured by a rear-facing camera aboard the second vehicle. The merging may comprise de-emphasizing an occluded portion of the image captured by the forward-facing camera aboard the first vehicle, the occluded portion corresponding to occlusion by the second vehicle, and emphasizing an unoccluded portion of the image captured by the rear-facing camera aboard the second vehicle.

The sequence of mixed-reality images may be presented to the driver of the first vehicle while the first vehicle is positioned to execute an unprotected left turn with opposing direction traffic. The sequence of mixed-reality images may be presented to the driver of the first vehicle while the second vehicle is also positioned to execute an unprotected left turn with opposing direction traffic. The sequence of mixed-reality images may be presented to the driver of the first vehicle upon a determination that a field of view of the image captured by the forward-facing camera of the first vehicle overlaps with a field of view of the image captured by the rear-facing camera of the second vehicle. The sequence of mixed-reality images may be presented to the driver of the first vehicle upon a confirmation that the first vehicle and the second vehicle are in front of each other. The confirmation may be based on at least one of (a) one or more forward-facing sensor measurements taken aboard the first vehicle, (b) one or more forward-facing sensor measurements taken aboard the second vehicle, (c) a global positioning system (GPS) measurement taken aboard the first vehicle, or (d) a GPS measurement taken aboard the second vehicle.

Optionally, the at least one image may be further augmented to include a representation of a traffic signal. The at least one image may be further augmented to include a warning regarding an approaching third vehicle traveling in a substantially same direction as the second vehicle. The warning regarding the approaching third vehicle may be triggered based on presence of the approaching third vehicle in a blind spot of the second vehicle, a measurement of distance between the second vehicle and the third vehicle, and/or a measurement of speed of the third vehicle.

### BRIEF DESCRIPTION OF THE DRAWINGS

FIG. 1 presents a simplified diagram of an intersection where unprotected left turns may occur;

FIG. 2 presents a simplified diagram illustrating the use of “see-through” functionality to improve visibility for vehicles making an unprotected left turn, according to an embodiment of the disclosure;

FIG. 3 presents an overview of various hardware components used to implement “see-through” mixed reality involving a first vehicle oriented in a substantially opposing direction relative to a second vehicle, according to an embodiment of the disclosure;

FIG. 4 presents a block diagram showing a sequence of illustrative actions to implement “see through” functionality in an opposing left turn scenario, by merging an image by a front-facing camera aboard a first vehicle with an image captured by a rear-facing camera aboard a second vehicle facing the first vehicle, according to an embodiment of the disclosure;

FIG. 5 is a flow chart showing an illustrative process for providing a “see-through” mixed-reality scene, according to an embodiment of the disclosure; and

FIG. 6 is a block diagram of internal components of an example of an electronic control unit (ECU) that may be implemented according to an embodiment.

### DETAILED DESCRIPTION

Several illustrative embodiments will now be described with respect to the accompanying drawings, which form a part hereof While particular embodiments, in which one or more aspects of the disclosure may be implemented, are described below, other embodiments may be used and various modifications may be made without departing from the scope of the disclosure or the spirit of the appended claims.

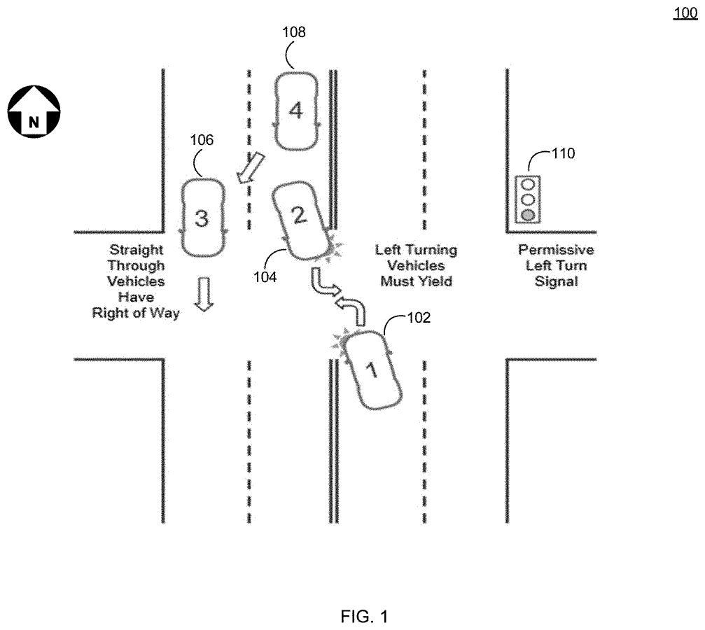

FIG. 1 presents a simplified diagram of an intersection 100 where unprotected left turns may occur. Four vehicles are shown at the intersection 100, including a first vehicle 102, a second vehicle 104, a third vehicle 106, and a fourth vehicle 108. The first vehicle 102 is attempting to make an unprotected left turn. At the same time, the second vehicle 104 is also attempting to make an unprotected left turn of its own. As shown, the first vehicle 102 is oriented in a substantially opposing direction relative to the second vehicle 104. However, the first vehicle 102 and the second vehicle 104 are each blocking the view of the other and thus limiting the view of each driver to see on-coming traffic. Here, “substantially opposing” is meant broadly to convey that the two vehicles are generally opposing each other in their orientation. However, the orientation of the first vehicle 102 does not have to be exactly opposite, i.e., 180 degrees from, the orientation of the second vehicle 104. Oftentimes, each vehicle may have started to turn slightly left in anticipation of making its left turn, and the degree to which each vehicle has slight turned left may differ. Even with such differences and deviations in relative positions, two vehicles that are generally opposing each other may still be considered to have “substantially opposing” orientations.

An intersection could be uncontrolled, i.e., there is no traffic light or stop sign, or the intersection could be traffic signal controlled with a permissive green signal phase (as shown in FIG. 1). The meaning of traffic signals can vary depending on jurisdiction, country, etc. For example, in many jurisdictions, a permissive green signal phase is generally represented by a solid green light, indicating that left turning traffic must yield to oncoming traffic. A permissive green signal phase may be distinguished from a protected left turn signal phase. Such a protected left turn signal phase is generally represented by a solid green left turn arrow, indicating that during a protected left turn phase, the left turning traffic has the right of way, while the oncoming traffic must stop, typically represented with a red light. In FIG. 1, the intersection 100 has no protected left turn signal phase. Instead, intersection 100 has only a permissive left turn signal 110. Here, permissive left turn signal 110 is a simple traffic signal that either permits traffic to flow in one orthogonal direction (e.g., north-south traffic flow) or another orthogonal direction (e.g., east-west traffic flow). For example, in FIG. 1, when permissive left turn signal 110 is “green,” all north-south traffic is allowed to flow—i.e., the first vehicle 102 is permitted to travel north through the intersection 100 or make a left turn at intersection 100, and each of the second vehicle 104, the third vehicle 106, and the fourth vehicle 108 is permitted to travel south through the intersection 100 or make a left turn at intersection 100. An intersection may be designed with either permissive or protected, or in some cases both types of left turn signal phases. Also, an intersection may have a dedicated left turn lane, or it may not (as shown in FIG. 1).

Limited visibility of on-coming traffic in an unprotected-left scenario can pose serious dangers and cause inefficient traffic flow, as illustrated in FIG. 1. While the first vehicle 102 and the second vehicle 104 are positioned to make their respective left turns, they are blocking each other's view of on-coming traffic. For example, the third vehicle 106 may be traveling in the same direction (e.g., south bound) but in an adjacent lane as the second vehicle 104. However, from the perspective of the driver of the first vehicle 102, a view of the third vehicle 106 may be blocked by the second vehicle 104. Depending on the relative positions of the vehicles, the degree of blockage of visibility may differ. The third vehicle 106 may be partially or even completed blocked from view. Thus, the third vehicle 106 may represent dangerous on-coming traffic that is blocked from view from the perspective of the first vehicle 102. While making the unprotected left turn, the driver of the first vehicle 102 may not see the third vehicle 106 until it is too late, causing a collision at the intersection 100.

The fourth vehicle 108 also has the potential to become dangerous on-coming traffic for the first vehicle 102. Here, the fourth vehicle 108 is positioned behind the second vehicle 104. The driver of the fourth vehicle 108 may grow impatient while waiting behind the second vehicle 104, which is stopped while attempting to make its own unprotected left turn. Consequently, the driver of the fourth vehicle 108 may attempt to overtake or pass the second vehicle 104, by switching over to the adjacent lane, i.e., the lane in which the third vehicle 106 is traveling, in order to travel through the intersection 100 while the permissive left turn signal is still “green.” From the perspective of the driver of the first vehicle 102, a view of the fourth vehicle 108 may also be blocked by the second vehicle 104, either partially or completely. It may also be difficult to understand the intention of the fourth vehicle 108, since its turn signals may be blocked from view by the presence of the second vehicle 104.

The situation may be exacerbated in crowded traffic conditions in which drivers are rushing to pass through the intersection 100. Just as an example, the driver of the fourth vehicle 108, while attempting to overtake or pass the second vehicle 104, may attempt to merge into the adjacent lane by “shooting the gap” in the flow of traffic in that lane. There may be a gap between the third vehicle 106 and the vehicle immediately behind the third vehicle 106. If there is such a gap behind the third vehicle 106, the fourth vehicle 108 may attempt to quickly accelerate to merge into the adjacent lane and travel behind the third vehicle 106. Meanwhile, the driver of the first vehicle 102 may also attempt to “shoot the gap”—i.e., the same gap—by making a left turn to traverse the intersection 100 and travel through the gap behind the third vehicle 106. Due to blockage of visibility caused by the second vehicle 104, the driver of the first vehicle may have no idea that the “gap” has been filled by the fourth vehicle 108. Both the first vehicle 102 and the fourth vehicle 108 may proceed and collide with one another at intersection 100.

Scenarios such as those described above, in which the view of a vehicle attempting to make an unprotected left turn is partially or completely blocked by an opposing vehicle also attempting to make a left turn, can lead to serious accidents such as head-on or semi head-on collisions between vehicles. They can also cause secondary accidents such as vehicle-pedestrian collisions, e.g., a vehicle may strike a pedestrian as a result of distraction or a swerving maneuver to avoid a vehicle-vehicle collision. In addition, blocked visibility may significantly reduce traffic efficiency. For example, a driver may hesitate or become unwilling to carry out an unprotected left turn that otherwise would have been possible, but for the driver's fear of the existence of on-coming traffic in a region that is blocked from view.

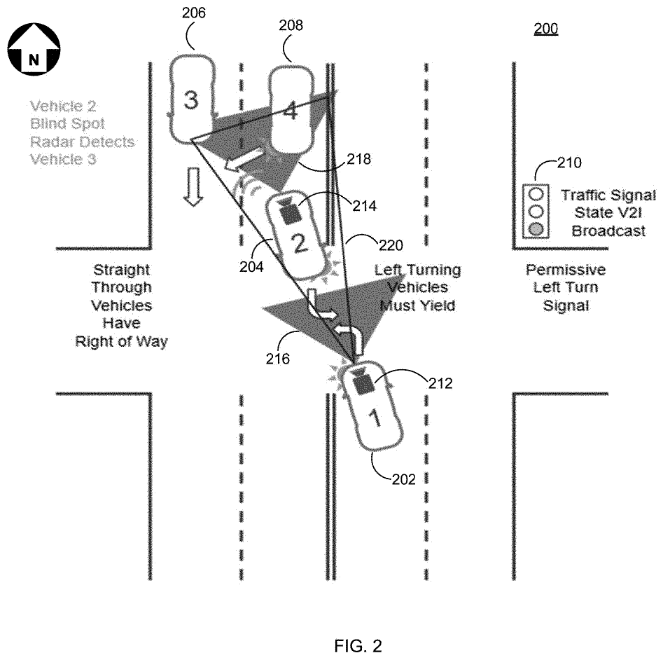

FIG. 2 presents a simplified diagram illustrating the use of “see-through” functionality to improve visibility for vehicles making an unprotected left turn, according to an embodiment of the disclosure. Similar to FIG. 1, an intersection 200 is shown where four vehicles are present, including a first vehicle 202, a second vehicle 204, a third vehicle 206, and a fourth vehicle 208. A permissive left turn signal 210 is shown, which (assuming the permissive left turn signal 210 is “green”) permits north-south traffic flow, but does not provide a way for the first vehicle 202 or the second vehicle 204 to make a protected left turn. Instead, the first vehicle 202 and the second vehicle 204 are both attempting to make an unprotected left turn, and by virtue of the maneuver, positioned in such a way that the second vehicle 204 naturally blocks the vision of the first vehicle 202, and vice versa. The driver of the first vehicle 202 cannot see the approaching third vehicle 206 or the turn signal on the fourth vehicle 208 that would indicate that the fourth vehicle 208 intends to pass the second vehicle 204 as soon as it is able.

According to an embodiment of the disclosure, see-through functionality may be achieved by presenting a sequence of mixed-reality images to the driver of the first vehicle 202. As mentioned, the first vehicle 202 may be oriented in a substantially opposing direction relative to the second vehicle 204. At least one image in the sequence of mixed-reality images may result from merging (a) an image captured by a forward-facing camera 212 aboard the first vehicle 202 and (b) an image captured by a rear-facing camera 214 aboard the second vehicle 204. The forward-facing camera 212 may have a field of view 216. The rear-facing camera 214 may have a field of view 218. The merging may comprise de-emphasizing an occluded portion of the image captured by the forward-facing camera 212 aboard the first vehicle 202 and emphasizing an unoccluded portion of the image captured by the rear-facing camera 214 aboard the second vehicle 204. The occluded portion may correspond to occlusion, by the second vehicle 204, of some or part of the field of view 216 of the camera 212 aboard the first vehicle 202. As shown in FIG. 2, such an occlusion portion may correspond with an area of overlap 220 between (i) the field of view 216 of the forward-facing camera 212 aboard the first vehicle 202 and (ii) the field of view 218 of the rear-facing camera 214 aboard the second vehicle 204. Furthermore, if similarly equipped, the second vehicle 204 may provide a similar see-through functionality to its driver, to see through the first vehicle 202 while making its unprotected left turn.

De-emphasizing and emphasizing may be performed in different ways. In one embodiment, de-emphasizing and emphasizing is accomplished by blending the image captured by the forward-facing camera 212 aboard the first vehicle 202 and the image captured by the rear-facing camera 214 aboard the second vehicle 204. Such image blending may be performed using various digital composting techniques. Just as an example, digital composting using alpha blending may be implemented. Different portions of the image may be combined using different weights. Also, gradients may be used for the combining. For instance, the center region of the merged image may be associated with a first blending factor (e.g., a constant referred to as “alpha_1”), and the regions at the outer borders of the merged image may be associated with a second blending factor (e.g., a constant referred to as “alpha_2”). Just as an example, the blending factor may increase linearly from alpha__1 to alpha__2 between the center region and the regions at the outer borders of the merged image. In another embodiment, de-emphasizing and emphasizing is accomplished by simply replacing the occluded portion of the image captured by the forward-facing camera 212 aboard the first vehicle 202 with the unoccluded portion of the image captured by the rear-facing camera 214 aboard the second vehicle 204, to form the see-through region of the merged image.

Additional optional components may also be included in the system. One optional component relates to augmenting the see-through functionality, such that a merged image also includes a representation of a traffic signal. When a driver's attention is focused on a display device showing the see-through view of the scene, as discussed above, it may be difficult for the driver to also pay attention to traffic control devices present in the environment external to the vehicle, such as permissive left turn signal 210. Indeed, paying attention to both the vehicle's display device showing the see-through view and the permissive left turn signal 210 may require the driver to switch back and forth between two different gaze directions, which can be challenging. According to an embodiment of the present disclosure, one or more of the merged images provided for “see-through” functionality may also provide a representation of a traffic signal, e.g., as an overlay on top of the see-through, merged image. During a left-turn maneuver, such an augmented display can be very useful to the driver, as the driver is focused on on-coming traffic, and the placement of the physical traffic signal, e.g., permissive left turn signal 210, often makes it difficult to see.

Another optional component relates to augmenting the see-through functionality such that the merged image also includes a warning regarding an approaching third vehicle, e.g., third vehicle 206, traveling in a substantially same direction as the opposing vehicle, e.g., second vehicle 204, that is blocking the view of the driver of the first vehicle 202. In one embodiment, the warning regarding the approaching third vehicle 206 is triggered based on the presence of the approaching third vehicle 206 in a blind spot of the second vehicle 204. In another embodiment, the warning regarding the approaching third vehicle 206 is triggered based on a measurement of distance between the second vehicle 204 and the third vehicle 206. In yet another embodiment, the warning regarding the approaching third vehicle 206 is triggered based on a measurement of speed of the third vehicle 206. Existing sensors aboard the second vehicle 204 may be used to make such measurements of the presence, location, and speed of the third vehicle 206. Examples of such sensors may include side-facing or rear-facing Light Detection and Ranging (LIDAR) and/or Radio Detection and Ranging (RADAR) detectors. Such sensors may already exist aboard the second vehicle 204 to serve functions such as blind spot detection or a near-field safety cocoon. Raw sensor measurements and/or results generated based on the sensor measurements may be wirelessly communicated to the first vehicle 202. Such wireless communication may be conducted using direct vehicle-to-vehicle (V2V) communication between the first vehicle 202 and the second vehicle 204, or conducted via over a cloud-based server, as discussed in more detail in subsequent sections. Thus, as part of the see-through functionality, the system may provide additional shared sensor information from the second vehicle 204 to aid the driver of the first vehicle 202 in deciding when it is safe to make the unprotected left turn.

The presently described “see-through” functionality as used to improve left turn maneuvers possesses significant advantages over existing technologies. One advantage is that the “see-through” functionality can be implemented without necessarily requiring infrastructure improvements. For example, a solution that requires all vehicles traversing an intersection to be detected by infrastructure equipment or report their presence and intentions, e.g., via V2X communications, may require substantial equipment to be installed. Such solutions may not be feasible in the near term. By contrast, the “see-through” functionality described herein for improving left turn maneuvers may be realized based on vehicle rear-facing cameras and vehicle-based computing and communications resources, which are quickly becoming available in newer vehicles and do not require costly infrastructure expenditures.

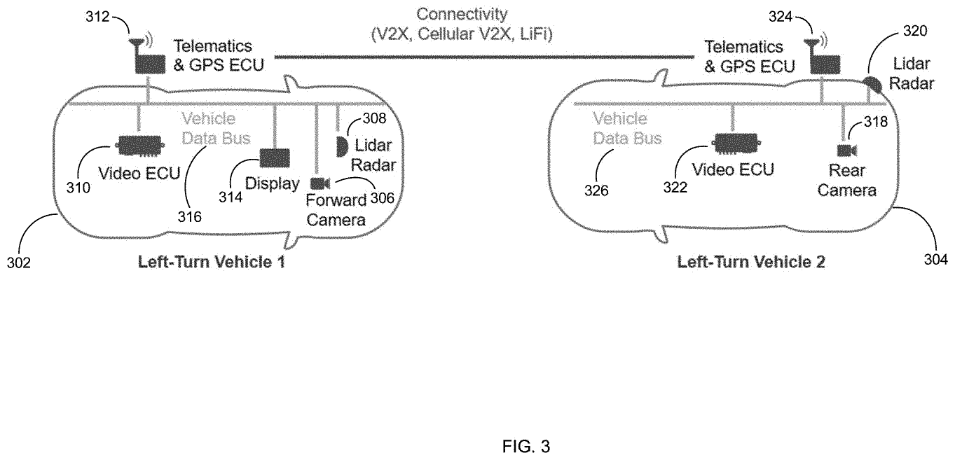

FIG. 3 presents an overview of various hardware components used to implement “see-through” mixed reality involving a first vehicle 302 oriented in a substantially opposing direction relative to a second vehicle 304, according to an embodiment of the disclosure. The first vehicle 302 may be equipped with various devices including one or more forward-facing cameras 306, forward-facing Light Detection and Ranging (LIDAR) and/or Radio Detection and Ranging (RADAR) detectors 308, a video electronic control unit (ECU) 310, a telematics and global positioning system (GPS) ECU 312, and a display 314, all coupled to a vehicle data bus 316. The second vehicle 304 may be equipped with various devices including one or more rear-facing cameras 318, one or more side-facing or rear-facing LIDAR and/or RADAR detectors 320, a video ECU 322, and a telematics and GPS ECU 324, all coupled to a vehicle data bus 326. An ECU, such as the video ECU 310 or 322, or the telematics and GPS ECU 312 or 314, may comprise one or more processors executing code for performing programmed instructions for carrying out specific tasks described herein. An ECU may also incorporate hardware components such as video, communications, positioning (e.g., GPS) components to support various functionalities.

These components aboard the first vehicle 302 and the second, opposing vehicle 304 may work together to communicate data and construct a mixed-reality scene, e.g., a “see-through” video stream, that is presented to the driver of the first vehicle 302. Rear-facing camera(s) 318 aboard the second vehicle 304 may provide a “see-through” view to the driver of the first vehicle 302, so that objects behind the second vehicle 304 that would otherwise be occluded from view can become visible. Aboard the second vehicle 304, the raw images from rear-facing cameras 318 may be forwarded to the video ECU 322 over the vehicle data bus 326. Here, the video ECU 322 may select the appropriate camera view or stitch together views of several of the rear-facing camera(s) 318, to form the images provided by the second vehicle 304. As shown, the video ECU 322 is implemented as a separate device on the vehicle data bus 326. However, in alternative embodiments, the video ECU 322 may be part of one or more of the rear-facing cameras 318 or integrated into the telematics and GPS ECU 324. Other alternative implementations are also possible for the components shown in FIG. 3.

Connectivity between the first vehicle 302 and the second vehicle 304 may be provided by telematics and GPS ECU 312 aboard the first vehicle 302 and the telematics and GPS ECU 324 aboard the second vehicle 304. For example, the images provided by the second vehicle 304 may be forwarded over a vehicle-to-vehicle (V2V) communications link established between telematics and GPU ECUs 324 and 312. Different types of V2V links may be established, such as WLAN V2V (DSRC), cellular V2V, Li-Fi, etc. Also, connectivity between the first vehicle 302 and the second vehicle 304 isn't necessarily restricted to V2V communications. Alternatively or additionally, the connectivity between the two vehicles may be established using vehicle-to-network (V2N) communications, e.g., forwarding data through an intermediate node.

At the first vehicle 302, similar components (e.g., a video ECU 310, a telematics and GPS ECU 312, etc.) and additional components, including one or more forward-cameras 306, the forward-facing LIDAR and/or RADAR detectors 308, and display 314 may be deployed. The forward-facing LIDAR and/or RADAR detectors 308 aboard the first vehicle 222 facilitate precise determination of the position of the second vehicle 304 relative to the first vehicle 302. The relative position determination may be useful in a number of ways. For example, the precise relative position of the second vehicle 304 may be used to confirm that the second vehicle is the correct partner with which to establish V2V communications. The precise relative position of the second vehicle 304 may also be used to enable and disable “see-through” functionality under appropriate circumstances, as well as control how images from the two vehicles are superimposed to form the see-through video stream. The video ECU 310 aboard the first vehicle 302 may perform the merger of the images from the second vehicle 304 and the images from the first vehicle 302, to generate the see-through video stream. The see-through video stream is presented to the driver of the first vehicle 302 on the display 314.

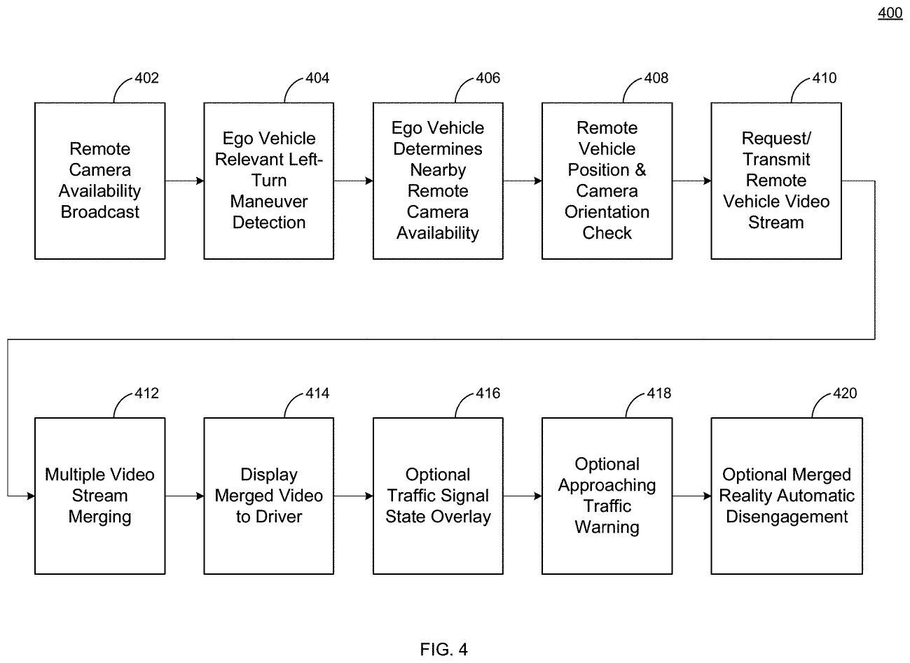

FIG. 4 presents a block diagram showing a sequence of illustrative actions to implement “see through” functionality in an opposing left turn scenario, by merging an image by a front-facing camera aboard a first vehicle with an image captured by a rear-facing camera aboard a second vehicle facing the first vehicle, according to an embodiment of the disclosure. In FIG. 4, the terms “ego vehicle” and “remote vehicle” are used. An example of such an ego vehicle may be the first vehicle 102, 202, or 302, and an example of the remote vehicle may be the second vehicle 104, 204, or 304, as shown in FIGS. 1, 2, and 3, respectively.

In a step 402, the remote vehicle may broadcast or register the availability of its rear-facing camera for viewing by other vehicles in the vicinity. For example, a camera availability message or record may include time, vehicle location (GPS), speed, orientation and travel direction, vehicle information (length, width, height). For each available camera, including any rear-facing cameras, the camera availability message may include the X-Y-Z mounting location, direction pointed (such as front, rear, side), and lens information, such as field of view, of the camera. According to one embodiment, the camera availability message may be broadcast as a direct signal sent to other vehicles within a physical range of wireless communication, to announce the vehicle location and the availability of camera services. For example, such a technique may be used for nearby vehicles communicating over DSRC, LTE Direct, Li-Fi, or other direct Vehicle-to-Vehicle (V2V) communication channel(s). According to another embodiment, the camera availability message may be sent to a cloud-based server using a wireless technology, such as cellular (4G or 5G) technology. The cloud-based server would aggregate vehicle locations and available camera services, allowing the data to be searched by vehicles that are not in direct vehicle-to-vehicle communication range.

In a step 404, the ego vehicle may detect a relevant left turn maneuver for triggering the “see-through” functionality using the rear-facing camera(s) of the remote vehicle. Here, the ego vehicle may use its available data to determine that its driver is attempting to perform a left-turn with opposing left-turning traffic that may be blocking the driver's view of oncoming traffic. Various types of data may be used to make such a determination, including the following types of data and combinations thereof:
Navigation system suggested route;
Driver activation of the left turn signal;
Camera-based scene analysis to determine lane markings and road geometry;
Forward sensor camera, RADAR, or LIDAR to determine that there is a stopped remote vehicle potentially blocking the view of the ego vehicle;
Camera-based scene analysis to determine if the remote vehicle, potentially blocking the view of the ego vehicle, has its left-turn signal activated;
Traffic signal detection, either camera-based or V2X broadcast to determine that the left turn is permissive, rather than protected;
The ego vehicle may also use its blind spot or near field RADAR or LIDAR to determine that traffic is approaching from the rear, meaning that the remote vehicle will likely continue to block the ego vehicle driver's vision, because there is no approaching gap in traffic through which the remote vehicle can complete its left-turn maneuver;
The ego vehicle may also detect license plate of the remote vehicle using image processing techniques to verify that the remote vehicle is in fact the vehicle in the opposing direction of the ego vehicle.

In a step 406, the ego vehicle may determine the availability of nearby remote camera(s). The ego vehicle video ECU and/or telematics unit may poll available data sources for nearby camera systems. This could be a list received from the cloud based on the ego vehicle's current GPS coordinates. Alternatively or additionally, it can be a compiled list of nearby vehicles whose broadcasts have indicated camera availability through direct communication such as DSRC, LTE Direct, or Li-Fi.

In a step 408, the ego vehicle may perform a remote vehicle position and camera orientation check. In other words, the ego vehicle may determine if any of the nearby available cameras belong to the opposing vehicle (who is also attempting to turn left and facing the ego vehicle). Such a check may include, for example, the following steps:
The ego vehicle video or telematics ECU may compare the remote cameras GPS position, heading, and camera direction (associated with the rear-facing camera of the remote vehicle) with the ego vehicle's GPS position, heading, and camera direction, to determine that there is sufficient overlap between the two camera fields of view.
The ego vehicle may compare its forward-facing sensor distance measurement to the remote vehicle (as measured by LIDAR and/or RADAR) to ensure that the vehicle determined to be in front of the ego vehicle based on GPS position is, indeed, the same vehicle that is being sensed by the LIDAR and/or RADAR readings.
If the remote vehicle is also equipped with forward-facing LIDAR and/or RADAR, the ego and remote vehicles may compare their forward sensor distance measurements to see if they match, thus ensuring that a both the ego and remote vehicles are directly in front of each other without any intervening vehicles.

In a step 410, the ego vehicle may request the remote vehicle's video stream. Here, if the ego vehicle determines that the remote vehicle is correctly positioned with an available rear-facing camera, the ego vehicle may request video stream(s) from the appropriate remote vehicle camera. An example of a series of steps for making such a request is presented below:
The ego vehicle ECU sends a video request message to the remote vehicle.
   Option 1: V2V-Based Video Request—the Telematics ECU of the ego vehicle sends a direct request to the remote vehicle for its video stream.
   Option 2: Cloud-Based Video Request—the data on how to request the video stream (such as IP address) could be stored in the cloud along with the remote vehicle's GPS record.
The ego and remote vehicles may negotiate optional parameters such as:
   Preferred communication channel
   Video quality/compression based on signal strength
   The lead vehicle may use information provided by the ego vehicle to customize the video stream, such as cropping the image to reduce the required bandwidth
The remote vehicle ECU responds to the ego vehicle with the desired video stream
The ego vehicle ECU receives the remote vehicle's video stream

In a step 412, multiple video streams are merged together. In particular, an image captured by a forward-facing camera aboard the ego vehicle may be merged with an image captured by a rear-facing camera aboard the remote vehicle. Such merged images may form a merged video stream. The merging may take into account known ego and remote vehicle camera information, such as known GPS information about both vehicles, and the ego vehicle sensor data (RADAR, LIDAR, and/or camera-based object tracking). For example, the remote vehicle's camera stream may be transformed using known video synthesis techniques to appear as though the video was shot from the ego vehicle's point of view. Then, the remote camera video stream may be overlaid on the ego vehicle's camera stream to create a merged video that mixes the realities seen by both cameras.

In a step 414, the merged video stream is displayed to the driver of the ego vehicle. The resulting mixed reality or merged video may provide a view that is consistent with the ego-vehicle driver's point of view. The merged video may be displayed to the driver of the ego vehicle on a user interface including but not limited to a liquid crystal display (LCD), heads-up display (HUD), and/or other augmented reality (AR) display. The actual implementation of the user interface depicting the mixed reality view can take a number of different forms, for example:
The remote vehicle may be “disappeared” completely from the ego camera video;
The remote vehicle may appear as a partially transparent object in the ego vehicle's camera video;
The remote vehicle may appear as only an outline in the ego vehicle's camera scene;
Using a dynamic video point of view transition, the ego camera image may “zoom in on” or appear to “fly through” the lead vehicle, and give the driver the impression that the perspective has shifted from the ego vehicle to the remote vehicle.

In an optional step 416, the state of one or more traffic signals may be overlaid on the merged video stream displayed to the driver of the ego vehicle. Here, if the traffic signal state (e.g., green light) can be determined and monitored, it could be added to the information provided to the driver of the ego vehicle as an augmented reality overlay, e.g., next to the mixed reality see-through view. The traffic signal state could be determined in different ways, for example:
Traffic signal state may be broadcast using vehicle-to-infrastructure (V2I) communications, if the intersection is so equipped. For example, available V2X message sets already include traffic signal state in the SPAT (Single Phase And Timing) message.
The ego vehicle may use image recognition algorithms on a front camera to determine the traffic signal current state.

In an optional step 418, a warning may be provided to signal that another vehicle is approaching from the rear of the remote vehicle. As discussed previously, a vehicle that approaches from the rear of the remote vehicle may pose additional risks in an unprotected left turn scenario. For example, in FIG. 2, such an approaching vehicle may be the third vehicle 206 or potentially the fourth vehicle 208. If the remote vehicle (e.g., second vehicle 204 in FIG. 2) is equipped with rear or side facing RADAR or LIDAR, such as for blind spot detection or a near-field safety cocoon, such sensor readings may be used to detect the vehicle approaching from the rear. Typically, a rear-facing RADAR or LIDAR sensor could detect the following:
Vehicle presence within the blind spot
Distance from the rear of the remote vehicle
Speed of the approaching vehicle

Referring again to FIG. 4, vehicles approaching from the rear of the remote vehicle (e.g., second vehicle 204) are essentially the oncoming traffic that the ego vehicle (e.g., first vehicle 202) must avoid. Typically, any of the forward-facing sensors on the ego vehicle would be blocked by the position of remote vehicle. However, the remote vehicle's rear-facing or side-facing sensor may have a clear view of the approaching traffic. Thus, the remote vehicle may use its rear-facing or side-facing sensors to detect overtaking traffic, and share the data (over V2V wireless communication) with the ego vehicle.

For example, the ego vehicle may use its knowledge of its own position relative to the position of the remote vehicle as determined by GPS and forward-facing LIDAR and/or LIDAR to determine the following:
The identity of the approaching vehicle as detected by remote vehicle's distance to the intersection
Based on the approaching vehicle's speed, the estimated time at which the remote vehicle will reach or clear the intersection
Whether it is unsafe to execute a left turn in front of the approaching vehicle

If the remote vehicle rear sensor data is made available, the ego vehicle may incorporate the data and provide an optional augmented reality overlay, to warn the driver of ego vehicle that traffic is approaching, provide an estimated time for the approaching vehicle to reach the intersection, and whether or not it is currently safe to turn left in front of the approaching traffic. The driver of the ego vehicle can then use this warning/advice, along with the “see-through” view, to decide whether or not it is safe to turn left.

In an optional step 420, the “see-through” mixed-reality view may be automatically disengaged, upon detection of certain conditions, for example:
The camera aboard the ego vehicle and the camera aboard the remote vehicle becomes substantially misaligned, to the point that there is no longer sufficient overlap between the two camera views to accurately represent reality. This could happen if either the ego or remote vehicle begins its left turn after it finds a sufficient gap in traffic. It would also happen, depending on the geometry of the intersection, if one or both vehicles slowly creep forward while turning to the point where the cameras become too misaligned to reconcile.
If the ego vehicle, through onboard sensors such as RADAR, LIDAR, camera(s), ultrasonic sensors, etc., detects any new objects between the ego vehicle and the remote vehicle, such as pedestrians, motorcyclists, or bicyclists. In such a situation, the “see-through” mixed reality view may be disabled to prevent any objects between the ego vehicle and remote vehicle from becoming hidden or obscured by the “see-through” mixed reality view, causing a potential safety issue.

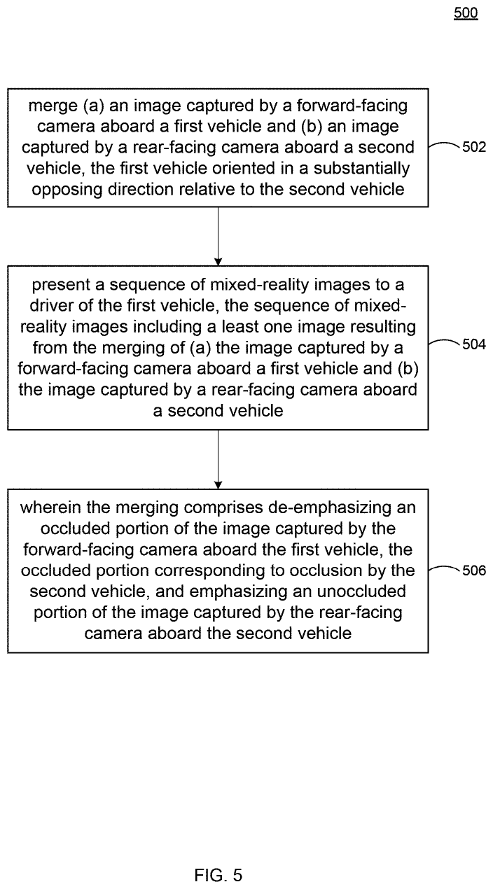

FIG. 5 is a flow chart showing an illustrative process 500 for providing a “see-through” mixed-reality scene, according to an embodiment of the disclosure. In a step 502, the process involves merging (a) an image captured by a forward-facing camera aboard a first vehicle and (b) an image captured by a rear-facing camera aboard a second vehicle, the first vehicle oriented in a substantially opposing direction relative to the second vehicle. In a step 504, the process involves presenting a sequence of mixed-reality images to a driver of the first vehicle, the sequence of mixed-reality images including a least one image resulting from the merging of (a) the image captured by a forward-facing camera aboard a first vehicle and (b) the image captured by a rear-facing camera aboard a second vehicle. In a step 506, the merging comprises de-emphasizing an occluded portion of the image captured by the forward-facing camera aboard the first vehicle, the occluded portion corresponding to occlusion by the second vehicle, and emphasizing an unoccluded portion of the image captured by the rear-facing camera aboard the second vehicle.

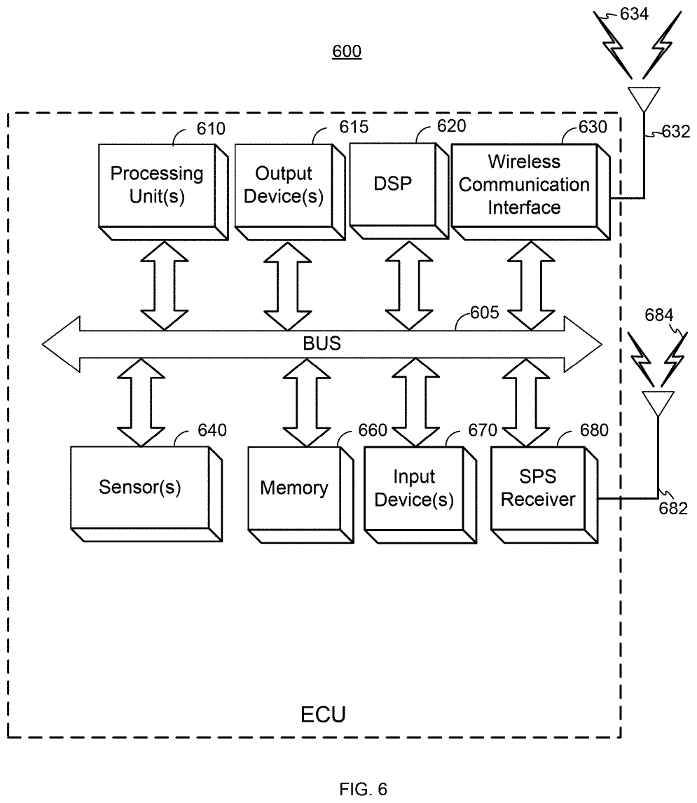

FIG. 6 is a block diagram of internal components of an example of an electronic control unit (ECU) that may be implemented according to an embodiment. For instance, ECU 600 may represent an implementation of a telematics and GPS ECU or a video ECU, discussed previously. It should be noted that FIG. 6 is meant only to provide a generalized illustration of various components, any or all of which may be utilized as appropriate. It can be noted that, in some instances, components illustrated by FIG. 6 can be localized to a single physical device and/or distributed among various networked devices, which may be disposed at different physical locations.

The ECU 600 is shown comprising hardware elements that can be electrically coupled via a bus 605 (or may otherwise be in communication, as appropriate). The hardware elements may include a processing unit(s) 610 which can include without limitation one or more general-purpose processors, one or more special-purpose processors (such as digital signal processing (DSP) chips, graphics acceleration processors, application specific integrated circuits (ASICs), and/or the like), and/or other processing structure or means. Some embodiments may have a separate DSP 620, depending on desired functionality. The device 600 also can include one or more input device controllers 670, which can control without limitation an in-vehicle touch screen, a touch pad, microphone, button(s), dial(s), switch(es), and/or the like; and one or more output device controllers 615, which can control without limitation a display, light emitting diode (LED), speakers, and/or the like.

The ECU 600 might also include a wireless communication interface 630, which can include without limitation a modem, a network card, an infrared communication device, a wireless communication device, and/or a chipset (such as a Bluetooth device, an IEEE 802.11 device, an IEEE 802.16.4 device, a WiFi device, a WiMax device, cellular communication facilities including 4G, 5G, etc.), and/or the like. The wireless communication interface 630 may permit data to be exchanged with a network, wireless access points, other computer systems, and/or any other electronic devices described herein. The communication can be carried out via one or more wireless communication antenna(s) 632 that send and/or receive wireless signals 634.

Depending on desired functionality, the wireless communication interface 630 can include separate transceivers to communicate with base transceiver stations (e.g., base stations of a cellular network) and/or access point(s). These different data networks can include various network types. Additionally, a Wireless Wide Area Network (WWAN) may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a WiMax (IEEE 802.16), and so on. A CDMA network may implement one or more radio access technologies (RATs) such as cdma2000, Wideband-CDMA (W-CDMA), and so on. Cdma2000 includes IS-95, IS-2000, and/or IS-856 standards. A TDMA network may implement Global System for Mobile Communications (GSM), Digital Advanced Mobile Phone System (D-AMPS), or some other RAT. An OFDMA network may employ LTE, LTE Advanced, and so on, including 4G and 5G technologies.

The ECU 600 can further include sensor controller(s) 640. Such controllers can control, without limitation, one or more accelerometer(s), gyroscope(s), camera(s), magnetometer(s), altimeter(s), microphone(s), proximity sensor(s), light sensor(s), and the like.

Embodiments of the ECU 600 may also include a Satellite Positioning System (SPS) receiver 680 capable of receiving signals 684 from one or more SPS satellites using an SPS antenna 682. The SPS receiver 680 can extract a position of the device, using conventional techniques, from satellites of an SPS system, such as a global navigation satellite system (GNSS) (e.g., Global Positioning System (GPS)), Galileo, Glonass, Compass, Quasi-Zenith Satellite System (QZSS) over Japan, Indian Regional Navigational Satellite System (IRNSS) over India, Beidou over China, and/or the like. Moreover, the SPS receiver 680 can be used various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi -functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The ECU 600 may further include and/or be in communication with a memory 660. The memory 660 can include, without limitation, local and/or network accessible storage, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The memory 660 of the device 600 also can comprise software elements (not shown), including an operating system, device drivers, executable libraries, and/or other code embedded in a computer-readable medium, such as one or more application programs, which may comprise computer programs provided by various embodiments, and/or may be designed to implement methods, and/or configure systems, provided by other embodiments, as described herein. In an aspect, then, such code and/or instructions can be used to configure and/or adapt a general purpose computer (or other device) to perform one or more operations in accordance with the described methods.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

What is claimed is:

1. A method for providing a mixed-reality scene comprising:
presenting a sequence of mixed-reality images to a driver of a first vehicle, the first vehicle oriented in a substantially opposing direction relative to a second vehicle;
wherein at least one image in the sequence of mixed-reality images results from merging (a) an image captured by a forward-facing camera aboard the first vehicle and (b) an image captured by a rear-facing camera aboard the second vehicle; and
wherein the merging comprises de-emphasizing an occluded portion of the image captured by the forward-facing camera aboard the first vehicle, the occluded portion corresponding to occlusion by the second vehicle, and emphasizing an unoccluded portion of the image captured by the rear-facing camera aboard the second vehicle.

2. The method of claim 1, wherein the sequence of mixed-reality images is presented to the driver of the first vehicle while the first vehicle is positioned to execute an unprotected left turn with opposing direction traffic.

3. The method of claim 2, wherein the sequence of mixed-reality images is presented to the driver of the first vehicle while the second vehicle is also positioned to execute an unprotected left turn with opposing direction traffic.

4. The method of claim 1, wherein the sequence of mixed-reality images is presented to the driver of the first vehicle upon a determination that a field of view of the image captured by the forward-facing camera of the first vehicle overlaps with a field of view of the image captured by the rear-facing camera of the second vehicle.

5. The method of claim 1, wherein the sequence of mixed-reality images is presented to the driver of the first vehicle upon a confirmation that the first vehicle and the second vehicle are in front of each other, the confirmation based on at least one of:
(a) one or more forward-facing sensor measurements taken aboard the first vehicle;
(b) one or more forward-facing sensor measurements taken aboard the second vehicle;
(c) a global positioning system (GPS) measurement taken aboard the first vehicle; or
(d) a GPS measurement taken aboard the second vehicle.

6. The method of claim 1, wherein the at least one image is further augmented to include a representation of a traffic signal.

7. The method of claim 1, wherein the at least one image is further augmented to include a warning regarding an approaching third vehicle traveling in a substantially same direction as the second vehicle.

8. The method of claim 7, wherein the warning regarding the approaching third vehicle is triggered based on presence of the approaching third vehicle in a blind spot of the second vehicle.

9. The method of claim 7, wherein the warning regarding the approaching third vehicle is triggered based on a measurement of distance between the second vehicle and the third vehicle.

10. The method of claim 7, wherein the warning regarding the approaching third vehicle is triggered based on a measurement of speed of the third vehicle.

11. An apparatus for providing a mixed-reality scene comprising:
an electronic control unit (ECU); and
a display,
wherein the ECU is configured to:
control presentation of a sequence of mixed-reality images to a driver of a first vehicle, the first vehicle oriented in a substantially opposing direction relative to a second vehicle;
wherein at least one image in the sequence of mixed-reality images results from merging (a) an image captured by a forward-facing camera aboard the first vehicle and (b) an image captured by a rear-facing camera aboard the second vehicle; and
wherein the merging comprises de-emphasizing an occluded portion of the image captured by the forward-facing camera aboard the first vehicle, the occluded portion corresponding to occlusion by the second vehicle, and emphasizing an unoccluded portion of the image captured by the rear-facing camera aboard the second vehicle.

12. The apparatus of claim 11, wherein the sequence of mixed-reality images is presented to the driver of the first vehicle while the first vehicle is positioned to execute an unprotected left turn with opposing direction traffic.

13. The apparatus of claim 12, wherein the sequence of mixed-reality images is presented to the driver of the first vehicle while the second vehicle is also positioned to execute an unprotected left turn with opposing direction traffic.

14. The apparatus of claim 11, wherein the sequence of mixed-reality images is presented to the driver of the first vehicle upon a determination that a field of view of the image captured by the forward-facing camera of the first vehicle overlaps with a field of view of the image captured by the rear-facing camera of the second vehicle.

15. The apparatus of claim 11, wherein the sequence of mixed-reality images is presented to the driver of the first vehicle upon a confirmation that the first vehicle and the second vehicle are in front of each other, the confirmation based on at least one of:
(a) one or more forward-facing sensor measurements taken aboard the first vehicle;
(b) one or more forward-facing sensor measurements taken aboard the second vehicle;
(c) a global positioning system (GPS) measurement taken aboard the first vehicle; or
(d) a GPS measurement taken aboard the second vehicle.

16. The apparatus of claim 11, wherein the at least one image is further augmented to include a representation of a traffic signal.

17. The apparatus of claim 11, wherein the at least one image is further augmented to include a warning regarding an approaching third vehicle traveling in a substantially same direction as the second vehicle.

18. The apparatus of claim 17, wherein the warning regarding the approaching third vehicle is triggered based on presence of the approaching third vehicle in a blind spot of the second vehicle.

19. The apparatus of claim 17, wherein the warning regarding the approaching third vehicle is triggered based on a measurement of distance between the second vehicle and the third vehicle.

20. A computer-readable storage medium containing instructions that, when executed by one or more processors of a computer, cause the one or more processors to:
cause a sequence of mixed-reality images to be presented to a driver of a first vehicle, the first vehicle oriented in a substantially opposing direction relative to a second vehicle;
wherein at least one image in the sequence of mixed-reality images results from merging (a) an image captured by a forward-facing camera aboard the first vehicle and (b) an image captured by a rear-facing camera aboard the second vehicle; and
wherein the merging comprises de-emphasizing an occluded portion of the image captured by the forward-facing camera aboard the first vehicle, the occluded portion corresponding to occlusion by the second vehicle, and emphasizing an unoccluded portion of the image captured by the rear-facing camera aboard the second vehicle.
